(19) United States
(12) Patent Application Publication
(10) Pub. No.: US 2018/0271029 A1
(43) Pub. Date: Sep. 27, 2018

(54) AUTOMATED PLANT MANAGEMENT

(71) Applicant: Mehdi Hatamian, Rancho Santa Margarita, CA (US)

(72) Inventor: Mehdi Hatamian, Rancho Santa Margarita, CA (US)

(21) Appl. No.: 15/466,846

(22) Filed: Mar. 22, 2017

(51) Int. Cl. A01G 9/24; G06K 9/62; G06K 9/46; A01G 1/00; A01G 9/26; A01G 9/00; A01G 25/16; A01G 7/04

(52) U.S. Cl. CPC A01G 9/24; G06K 9/6202; G06K 9/4652; G06K 9/6267; A01G 9/247; A01G 9/26; A01G 9/00; A01G 25/167; A01G 7/045; A01G 1/001

(57) ABSTRACT

A smart grow device includes a set of sensors with at least one camera; a set of care resources; and a controller able to at least partly control the set of care resources based on evaluation of data received from the set of sensors. An automated method of providing plant care includes: retrieving a set of sensor measurements; retrieving model plant data including a set of evaluation criteria; comparing the set of sensor measurements to the set of evaluation criteria in order to determine at least one plant status; and updating active plant data based on the at least one plant status and the set of sensor measurements. An automated plant care system includes: a set of sensors; a set of resources; multiple planters; and at least one controller able to at least partly control the set of resources based on evaluation of data received from the set of sensors.

### BACKGROUND

Various entities may grow, cultivate, and/or monitor a number of plants. Existing solutions require manual action, data collection, and/or feedback. Existing solutions require human interaction in evaluating plant condition, status, etc.

Thus there is a need for an automated system that is able to monitor plant status, direct care, and/or otherwise manage the growth of a number of plants.

### SUMMARY

Some embodiments provide a plant monitoring and care device. Such a device may include a set of sensors such as cameras, light sensors, pH sensors, moisture sensors, etc. and/or a set of resources such as irrigation sources, light sources, etc. The device may be able to interact with other such devices and/or devices such as user devices, servers, controllers, etc. in various system arrangements.

Plant evaluation and/or care may be specified using model plant information elements that may include, for instance, care values, status criteria, image libraries, etc. Such model plant elements may be defined in various appropriate ways (e.g., user specified values, default values, etc.).

Individual plants (and/or groups of plants) may be associated with specified monitoring and care devices (and/or sets of devices) and/or specified model plant elements.

The plant monitoring and care device may be able to retrieve data from the set of sensors and determine one or more statuses or states associated with a plant. Such data may include color image data of the plant or plants associated with the device, environmental data (e.g., temperature, moisture level, soil pH, light levels, etc.), and/or other appropriate data. The statuses may include elements such as a stage of growth, relative health of the plant(s), etc. The retrieved data, determined statuses, and/or other relevant information may be stored in a log associated with the plant monitoring and care device (and/or associated plants).

Based on the sensors measurements and/or other relevant factors (e.g., elapsed time, received requests, etc.), some embodiments may direct plant care utilizing the set of resources. The set of resources may include local resources that are directly controlled by the device of some embodiments and/or distributed resources that may be controlled by one or more messages or requests sent from the plant monitoring and care device.

Some embodiments may provide inventory management capabilities such that a grower or other interested party may be able to identify a list of plants that matches some specified criteria.

Some embodiments may evaluate plant care logs and plant performance (e.g., rate of growth, yield, etc.) in order to perform heuristic analysis and update specified care parameters.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of a smart grow device according to an exemplary embodiment;

FIG. 2 illustrates a schematic block diagram of a smart grow system that utilizes the smart grow device of FIG. 1;

FIGS. 3A-3F illustrate schematic block diagrams of various smart grow system layouts that utilize the smart grow system of FIG. 2;

FIG. 4 illustrates a data structure diagram of various data elements used by the smart grow system of FIG. 2;

FIG. 5 illustrates a message flow diagram of a communication algorithm used by the smart grow system of FIG. 2;

FIG. 6 illustrates a flow chart of an exemplary process that generates model plant definitions used by the smart grow device of FIG. 1 and/or the smart grow system of FIG. 2;

FIG. 7 illustrates a flow chart of an exemplary process that initializes a plant to be monitored by the smart grow device of FIG. 1 and/or the smart grow system of FIG. 2;

FIG. 8 illustrates a flow chart of an exemplary process that monitors plant status using the smart grow device of FIG. 1 and/or the smart grow system of FIG. 2;

FIG. 9 illustrates a flow chart of an exemplary process that monitors and directs plant care using the smart grow device of FIG. 1 and/or the smart grow system of FIG. 2;

FIG. 10 illustrates a flow chart of an exemplary process that monitors plant inventory using the smart grow device of FIG. 1 and/or the smart grow system of FIG. 2;

FIG. 11 illustrates a flow chart of an exemplary process that applies heuristic learning to plant care using the smart grow device of FIG. 1 and/or the smart grow system of FIG. 2; and

FIG. 12 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to manage, monitor, and care for plants.

Some embodiments include a device that may be able to measure various conditions and direct various care resources. The device may be included in a system that utilizes multiple devices, internal and external resources, internal and external sensors, external controllers or other devices, and/or other appropriate elements.

A first exemplary embodiment provides a smart grow device comprising: a set of sensors including at least one camera; a set of care resources; and a controller able to at least partly control the set of care resources based on evaluation of data received from the set of sensors.

A second exemplary embodiment provides an automated method of providing plant care, the method comprising: retrieving a set of sensor measurements; retrieving model plant data including a set of evaluation criteria; comparing the set of sensor measurements to the set of evaluation criteria in order to determine at least one plant status; and updating active plant data based on the at least one plant status and the set of sensor measurements.

A third exemplary embodiment provides an automated plant care system comprising: a set of sensors; a set of resources; a plurality of planters; and at least one controller able to at least partly control the set of resources based on evaluation of data received from the set of sensors.

Several more detailed embodiments are described in the sections below. Section I provides a description of an exemplary system architecture. Section II then describes various methods of operation used by some embodiments. Lastly, Section III describes a computer system which implements some of the embodiments.

System Architecture

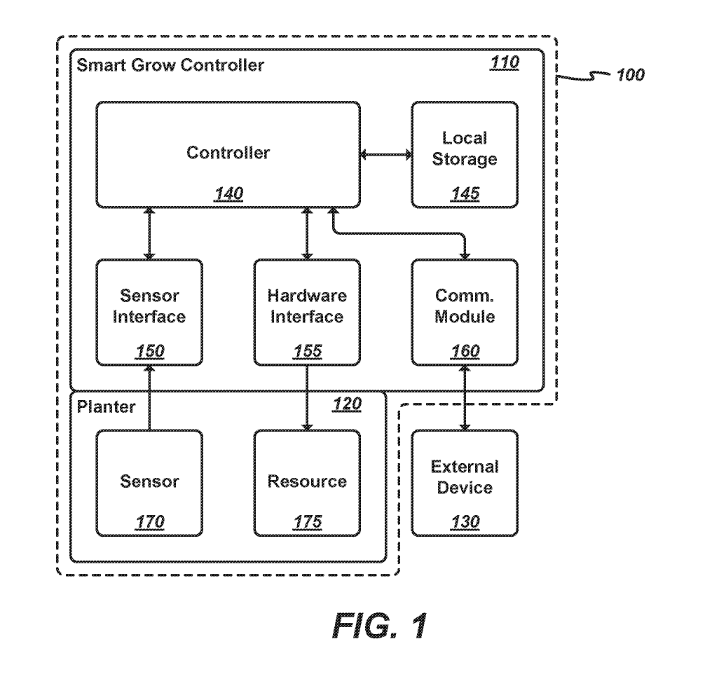

FIG. 1 illustrates a schematic block diagram of a smart grow device 100 according to an exemplary embodiment. As shown, the device may include a controller 110 and one or more planters 120. The device 100 may be able to interact with various external devices 130.

The smart grow controller 110 may include a controller module 140, local storage 145, a sensor interface 150, a hardware interface 155, and a communication module 160. The planter #9129 may include a number of sensors 170 and resources 175. Although the controller 110 and planter 120 are represented as separate elements, they may be combined or embedded in various ways (e.g., the controller 110 may be placed within the planter 120, the controller 110 may be adjacent to multiple planters 120, etc.).

The controller 140 may be an electronic device that is able to execute instructions and/or process data in order to interact with the various other components and/or direct the actions of other components. Local storage 145 may store data and instructions related to the care of plants growing in planter 120.

Sensor interface 150 may be able to retrieve data from one or more sensors 170 and provide the data to controller 140. The sensors 170 may be electronic devices able to measure various parameters associated with the planter 0120. Such sensors 170 may include, for instance, moisture sensors, light sensors, cameras, pH sensors, etc. In addition, some embodiments may include sensors such as radio receivers that are able to able to read IDs associated with the plants (e.g., radio frequency IDs). Although the sensors are shown as being included in the planter 120, the sensors 170 may be associated with multiple planters 120 or a grow area or otherwise be located outside a specific planter. For instance, a camera or light sensors may monitor conditions associated with multiple planters 120.

Each planter 120 may be an appropriate plant container, such as a pot, or simply an area, such as a location within a flower bed or other landscaping. Each planter may be able to retain suitable soils and/or other appropriate materials or mediums that are able to support and feed or nourish a plant. Each planter 120 may be able to house one or more plants.

Hardware interface 155 may be able to control or otherwise interact with various resources 175. The hardware resources may include, for instance, irrigation systems (e.g., sprinklers, nozzles, etc.), lighting systems, automated harvesters, pesticide systems, heating or cooling systems, etc. Although resources 175 are shown as being included in the planter 120, the resources 175 may be associated with multiple planters 120 or a grow area or otherwise be located outside a specific planter. For instance, a single irrigation system may supply water to multiple planters 120.

Communication module 160 may be able to communicate with various external devices 130 and/or other smart grow devices 100. The communication module 160 may include various wired and/or wireless communication channels. In some embodiments, the communication module may be able to communicate across one or more networks.

External device 130 may be any device that is able to interact with the smart grow device 100 via communication module 160. Such devices 130 may include, for instance, mobile devices such as smartphones, tablets, etc., computers or servers, etc. In addition, the external devices may include external sensors and/or resources.

Some embodiments may include various user interface elements that may at least partly direct the actions of technicians or other caregivers. For instance, some embodiments may include colored LEDs or other displays that may indicate whether a plant needs to be watered, fed, etc. Such user interface elements may indicate plant status or other attributes associated with the plant. In addition, some embodiments may include various user interface elements that allow a user to make a request or direct an action. For instance, a user may be able to manually activate a light source upon discovering a malfunction that prevented the light from being automatically provided.

In addition, some embodiments may include one or more web portals, applications, application programming interfaces (APIs), etc. that may allow various user devices such as smartphones, tablets, personal computers, etc. to interact with the device 100. Such elements may allow users to retrieve information, direct care, and/or otherwise interact with the device of some embodiments.

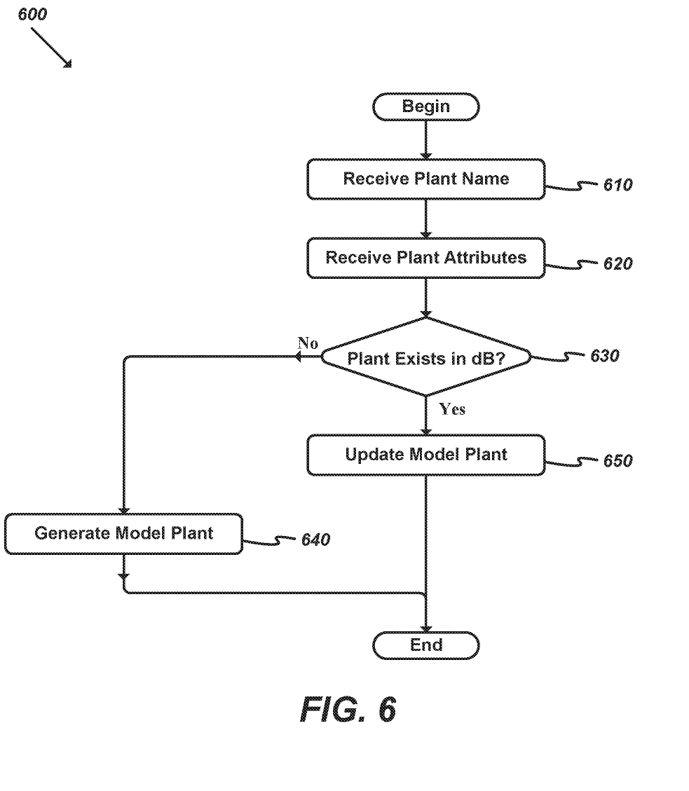

The operations of device 100 will be described in more detail below in reference to FIGS. 6-11.

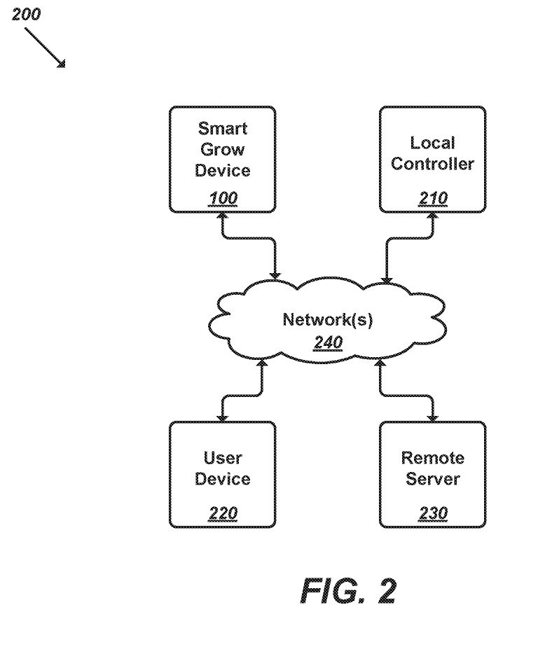

FIG. 2 illustrates a schematic block diagram of a smart grow system 200 that utilizes the smart grow device 100. As shown, the system may include a number of smart grow devices 100, one or more local controllers 210, one or more user devices 220, one or more remote servers 230, and one or more networks 240.

The local controller 210, user device 220, and/or remote server 230 may server as external device 130 described above. Networks 240 may include various wired and/or wireless connections (e.g., Ethernet, Wi-Fi, etc.), wireless communication channels (e.g., Bluetooth), and/or networks (e.g., cellular networks, local area networks, distributed networks, the Internet, etc.).

Different embodiments may include various numbers of each device 100 and 210-230. As in the example of FIG. 1, the smart grow device 100 may be a stand-alone system capable of monitoring and caring for one or more plants without needing to interact with any external devices or systems.

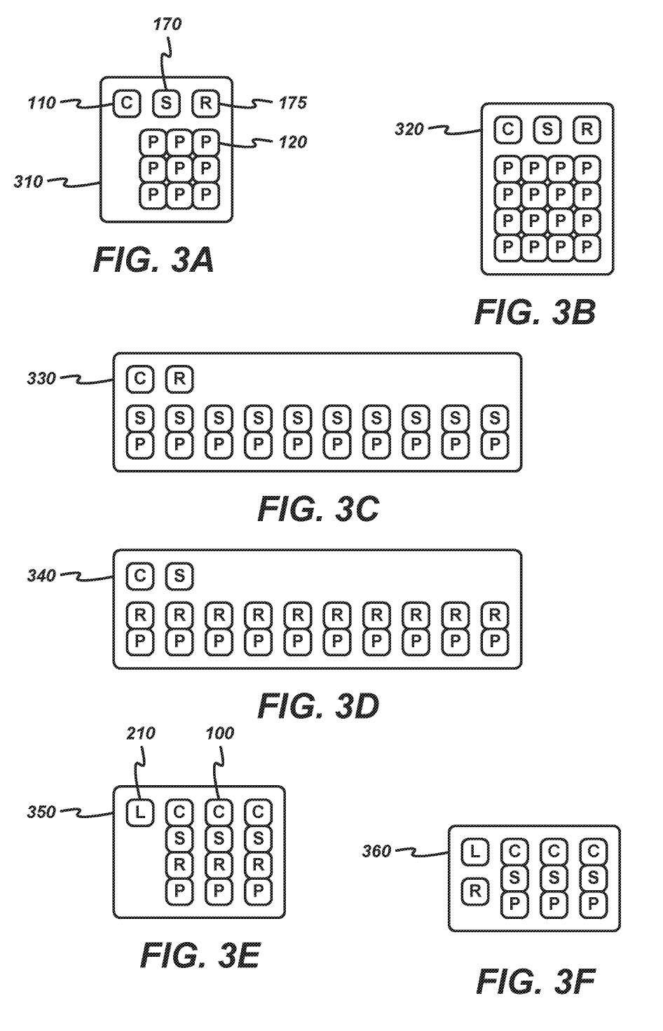

FIG. 3A illustrates a schematic block diagram of a first exemplary layout 310 that utilizes the smart grow system 200. As shown, the layout includes a smart grow controller 110, a set of sensors 170, a set of resources 175, and multiple planters 120. In this example, a single controller 110, set of sensors 170, and set of resources 175 are associated with multiple individual planters 120. Such an arrangement may be used, for example, to cultivate seedlings or small plants that may be stored on a pallet, box, or crate.

FIG. 3B illustrates a schematic block diagram of a second exemplary layout 320 that utilizes the smart grow system 200. In this example, a set of sixteen planters 120 is associated with a single controller 110, set of sensors 170, and set of resources 175.

FIG. 3C illustrates a schematic block diagram of a third exemplary layout 330 that utilizes the smart grow system 200. In this example, the planters 120 are arranged in a row, with each planter 120 having a distinct set of associated sensors 170. The planters 120 and associated sensors 170 may be associated with a single controller 110 and set of resources 175.

FIG. 3D illustrates a schematic block diagram of a fourth exemplary layout 340 that utilizes the smart grow system 200. In this example, the planters 120 are arranged in a row, with each planter 120 having a distinct set of associated resources 175. The planters 120 and associated resources 175 may be associated with a single controller 110 and set of sensors 170.

FIG. 3E illustrates a schematic block diagram of a fifth exemplary layout 350 that utilizes the smart grow system 200. In this example, each controller 110 is associated with a set of sensors 170, set of resources 175, and planter 120, such as described above in reference to device 100. The devices 100 are associated with a single local controller 210 (and/or a remote server and/or user device). The local controller may collect data from the various devices 100, direct the operations of the devices (e.g., by updating various threshold values such as moisture level, pH, by changing a light schedule, etc.), and/or perform other appropriate functions.

FIG. 3F illustrates a schematic block diagram of a sixth exemplary layout 360 that utilizes the smart grow system 200. In this example, each controller 110 is associated with a set of sensors 170 and a planter 120. All of the associated controllers 110, sets of sensors 170, and planters 120 are associated with a single local controller 210 (and/or a remote server and/or user device) and a set of shared resources 175 that may be at least partly controlled by the local controller 210. In addition, some embodiments may include devices 100 that have separate associated resources (e.g., an irrigation source) while other resources (e.g., a light source) are shared across the devices.

One of ordinary skill in the art will recognize that different embodiments may be implemented in various specific ways without departing from the scope of the disclosure. For instance, different embodiments may include layouts with different numbers of each individual element than shown and/or such elements may have various associated elements. As another example, various different arrangements may share resources, controllers, sensors, etc. across groups or sub-groups of elements. As still another example, each set of elements may have a different specific layout than shown (e.g., different numbers of planters, rows or columns of devices, etc.). Furthermore, the local controllers 210 and/or devices 100 (and/or components) may interact with various different external devices such as the user device 220 or remote server 230 described above.

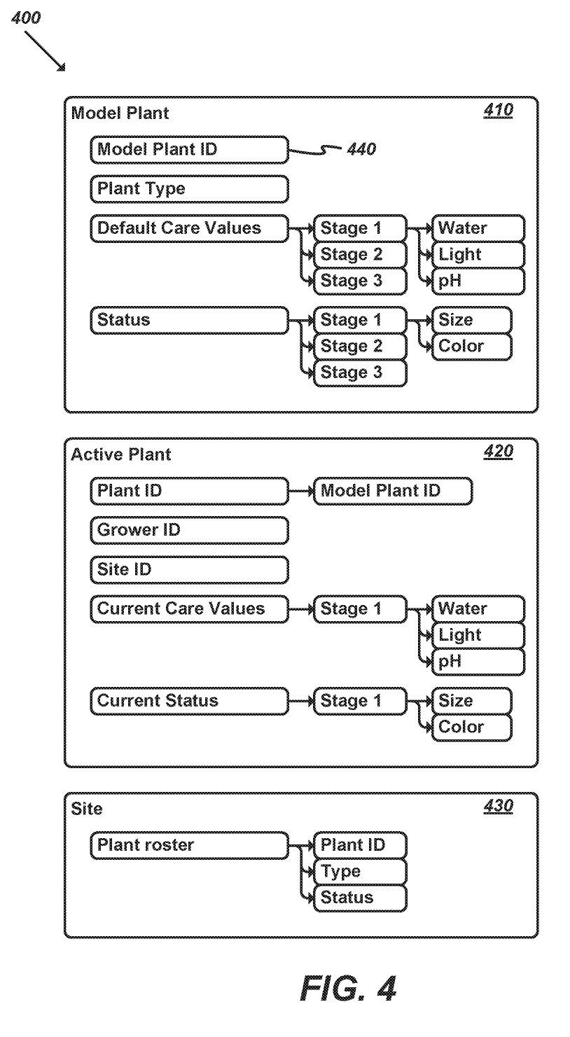

FIG. 4 illustrates a data structure diagram 400 of various data elements used by the smart grow system 200 and/or device 100. As shown, the data elements may include a model plant 410, an active plant 420, and a site 0430. Various other appropriate elements may be used by some embodiments.

As shown, the model plant element 410 may include sub-elements 440 such as model plant ID, type, default care values, status, etc. Each sub-element may be associated with additional sub-elements, as shown. For instance, default care values may be associated with multiple plant stages (e.g., “seedling”, “mature”, “flowering”, “dormant”, etc.) with each stage being associated with a set of parameter values or thresholds (e.g., moisture level, light schedule, etc.). Some embodiments may include status sub-elements associated with various stages as well (such stages may be the same stages associated with default care values or may be independent). Each status stage may be associated with parameters such as size (e.g., a height or weight), color, etc. Such parameters may be based on collated data associated with previously grown plants and may include libraries of images associated with various growth stages, health measures, etc.

Each active plant element 420 may include sub-elements 440 such as plant ID (which may be associated with a particular model plant 410 via the model plant ID), grower ID, site ID, etc. In this example, current care values may be retrieved by reference to the model plant and the current status. In addition to the size and color associated with a current status, some embodiments may collect and record information over time. Such information may include, for instance, sensor measurements, color images, size, status, etc. A similar data element to element 420 may be used for inactive plants, such as previously harvested plants. Such data elements may be used by heuristic learning algorithms of some embodiments.

Each site element 430 may include sub-elements 440 such as a site ID and a plant roster, with a list of plant IDs, types, statuses, etc. Each site may be associated with a growing area (e.g., a farm, nursery, etc.), sub-area (e.g., a field or greenhouse ID), and/or other appropriate groupings.

One of ordinary skill in the art will recognize that various other specific data elements and/or arrangements of elements may be used without departing from the scope of the disclosure. For instance, elements may include a technician ID that may be associated with various actions (e.g., collection of samples, evaluation of plant health, log of care administered to plants, etc.).

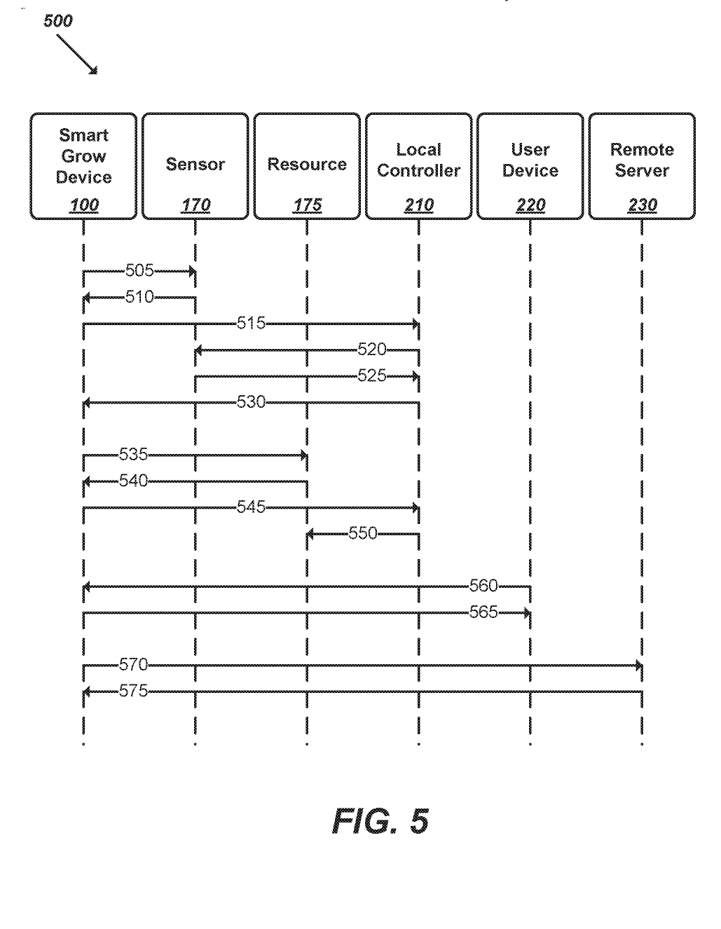

FIG. 5 illustrates a message flow diagram of a communication algorithm 500 used by the smart grow system 200.

As shown, the smart grow device 100 (via internal communication pathways or using the communication module 160) may send a request 505 for sensor information. Such a request may be sent at regular intervals, based on some threshold being met, and/or other appropriate criteria. The sensor may respond 510 with the requested measurement.

In some cases, the smart device 100 and sensor 170 may not be able to communicate directly. In such cases, an intermediary such as local controller 210 (and/or user device 220 and/or server 230) may be used. In this example, request 515 is sent to the local controller 210, which, in turn, sends a request 520 to the sensor 170. The sensor then sends a response 525 to the local controller 210 which then relays the response 530 to the requesting smart device 100.

As another example, the smart device 100 may send a request 535 to a resource 175. Such a request or command may, for instance, activate a resource such as irrigation or lighting. The resource may send an acknowledgement 540 to the requesting device 100, if appropriate.

If the smart device is not able to interact with the resource directly, a request 545 may be sent to the local controller 210 which sends a request or command 550 to the resource. In some cases, the resource 175 may send a response to the local controller 210 which may also send an acknowledgement or response to the smart device 100.

As still another example, a user device 220 (and/or local controller 210 and/or remote server 230) may send a request 560 to a smart device 100. Such a request may be generated by a technician or other user and may request action (e.g., to manually activate a light source or irrigation resource), data (e.g., sensor measurements, images, etc.), etc. In some cases, the request may include updated operating parameters, thresholds, etc. The smart device 100 may send a response 565 to the user device 220.

In the final example, a smart device 100 sends a request 570 to a remote server 230 (and/or user device 220 and/or controller 210). Such a request may include, for instance, a request for updated operating parameters, thresholds, etc. Message 570 may include data related to the device 100, such as plant IDs, statuses, sensor measurements, etc. The remote server 230 may send a response 575. The response may include requested data, if any, acknowledgement of receipt of the message 570, etc.

One of ordinary skill in the art will recognize that algorithm 500 may be implemented in various different ways without departing from the scope of the disclosure. For instance, additional messages may be sent among devices.

### II. Methods of Operation

FIG. 6 illustrates a flow chart of an exemplary process 600 that generates model plant definitions used by the smart grow device 100 and/or the smart grow system 200. Such a process may be performed by a device such as smart device 100, local controller 210, user device 220, and/or remote server 230. The process may begin, for instance, when a user activates a device or application of some embodiments. Such a process may be used to generate and/or update an element such as model plant 410 described above.

As shown, the process may receive (at 610) a plan name and then receive (at 620) various plant attributes. Such attributes may include, for instance, plant type, default care values, a list of statuses, threshold values, images, etc. In the case of images, a library of images may be used to evaluate various plant status(es), such as growth stage, state (e.g., flowering, bearing fruit, ripe, etc.), and/or other appropriate attributes. The images may be indexed by, for example, time elapsed since planting, plant size, plant health, pest or disease, etc.

Next, process 600 may determine (at 630) whether the plant exists in the database of plants. If the process determines (at 630) that the plant does not already exist, the process may generate (at 640) the model plant data element and then may end. If the process determines (at 630) that the plant does already exist in the database, the process may update (at 650) the attributes associated with the model plant and then may end.

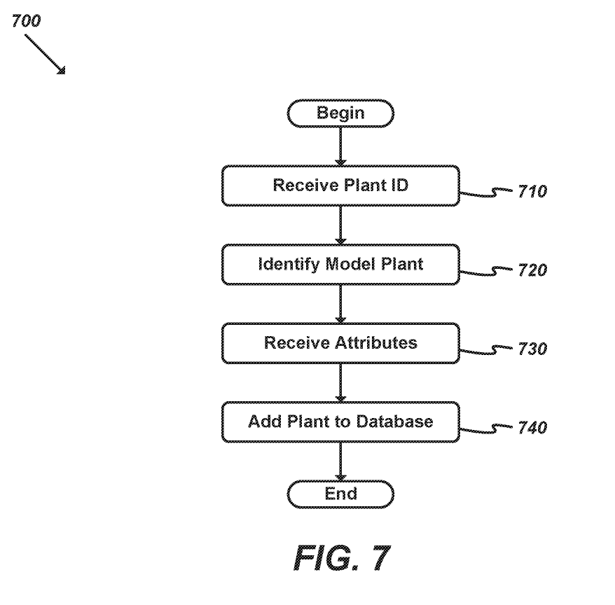

FIG. 7 illustrates a flow chart of an exemplary process 700 that initializes a plant to be monitored by the smart grow device 100 and/or the smart grow system 200. Such a process may be performed by a device such as smart device 100, local controller 210, user device 220, and/or remote server 230. The process may begin, for instance, when a plant is added to a device or planter of some embodiments. Such a process may be used to generate and/or update an element such as active plant 420 described above.

As shown, the process may receive (at 710) a plant ID. Such an identifier may be received in various appropriate ways. For instance, a technician or other user may provide the plant ID via an application of some embodiments. As another example, some embodiments may use an included camera (and/or other appropriate sensor) to scan a graphic code, capture an image of the plant, and/or otherwise gather identifying information. Such information may be compared to a plant database.

Next, the process may identify (at 720) a model plant associated with the plant ID. Such a model plant may be identified in various appropriate ways (e.g., by comparing captured information to a database, by requesting a model plant ID or name from a user, etc.).

Process 700 may then receive (at 730) attributes associated with the identified model plant. Such attributes may be received at (and/or retrieved by) a device such as device 100 and may be provided by a local storage or appropriate external device. Other attributes may be associated with the plant itself (e.g., location, site ID, status, etc.). Such attributes may be collected via an appropriate application or interface.

The process may then add (at 740) the plant to the plant database and then may end.

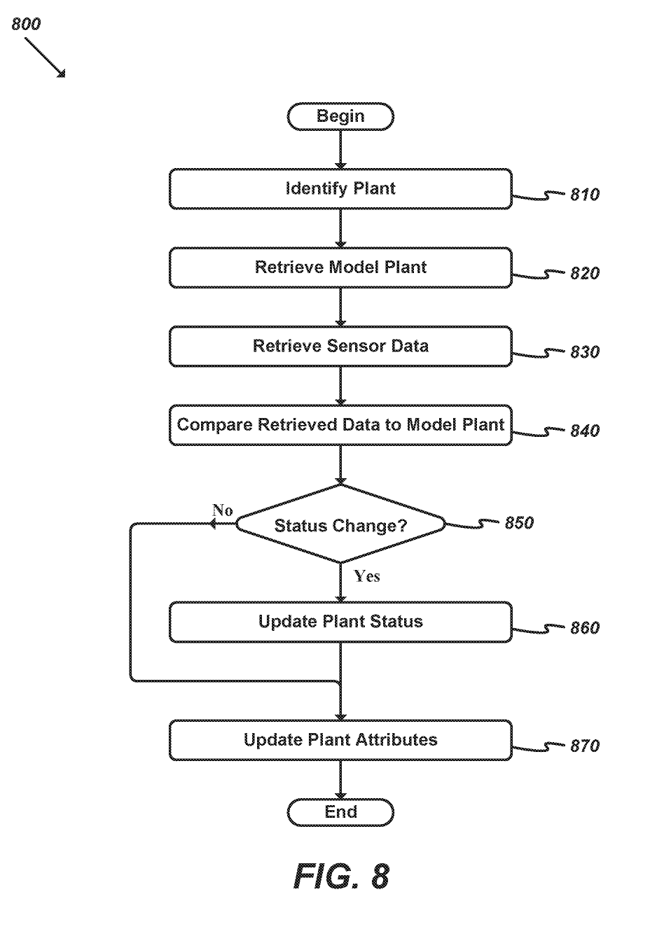

FIG. 8 illustrates a flow chart of an exemplary process 800 that monitors plant status using the smart grow device 100 and/or the smart grow system 200. Such a process may be performed by a device such as smart device 100, local controller 210, user device 220, and/or remote server 230. The process may begin, for instance, when a status request is received from a user device. In some embodiments the process may be run at regular intervals or based on some event criteria. Such a process may be used to generate and/or update an element such as active plant 420 described above.

As shown, the process may identify (at 810) the plant. The plant may be identified in various appropriate ways. For instance, there may be a map or other database of plant locations. As another example, the plant may have a graphic code, radio frequency ID, and/or other appropriate identifiers that may be able to be perceived by the device or system of some embodiments. As yet another example, the model plant ID may be retrieved from an active plant data element.

Next, the process may retrieve (at 820) model plant data associated with the plant ID. The model plant data may be retrieved from a local resource such as device storage 145 and/or a remote resource such as server 230.

Process 800 may then retrieve (at 830) sensor data. Such data may be retrieved from local sensors such as described in reference to device 100 or via other resources such as local controller #210, user device 220, or server 230, for instance.

Next, the process may compare (at 840) the retrieved sensor data to model plant data. Such comparison may include, for instance, comparing measured values such as moisture level, pH, weight, etc. to various threshold values. As another example, image data may be captured and compared to a size reference (e.g., a post or ruler placed within the planter) to determine whether a plant has exceeded a threshold. In some embodiments, captured image data may be compared to an image library associated with the model plant. Such comparison may include, for instance, color comparison, size comparison, shape comparison, etc.

The process may then determine (at 850) whether a status change is needed. Such a determination may be made based on a current status (and/or default status for new plants) and the retrieved sensor data. In some embodiments, a technician or user may manually enter status updates.

If the process determines (at 850) that a status change is needed, the process may then update (at 860) the plant status. Such an update may involve updating data element values in the active plant element 420. Some embodiments may include multiple status elements. For instance, some embodiments may utilize a plant stage status (e.g., “seedling”, “mature”, etc.), a plant health status (e.g., “good”, “fair”, “poor”, etc.), plant count for multi-plant planters, and/or other appropriate status elements.

If the process determines (at 850) that no status change is needed, or after updating (at 860) the status, the process may update (at 870) plant attributes and then may end. Such attributes may be updated, for instance, by updating values stored in an active plant data element. The attributes may include, for instance, plant size, color level, measured sensor values, etc.

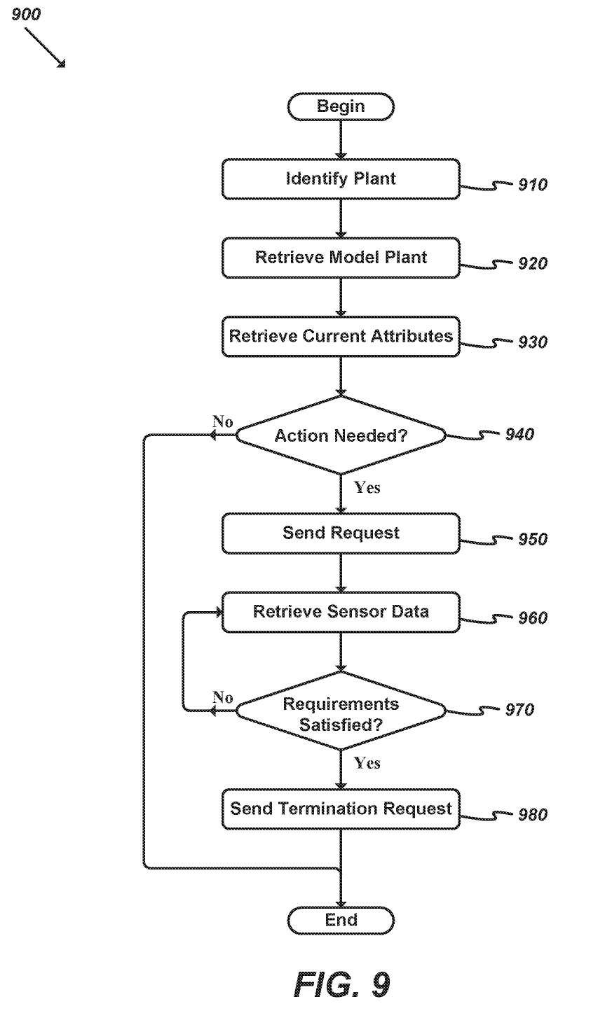

FIG. 9 illustrates a flow chart of an exemplary process 900 that monitors and directs plant care using the smart grow device 100 and/or the smart grow system 200. Such a process may be performed by a device such as smart device 100, local controller 210, user device 220, and/or remote server 230. The process may be run at regular intervals or based on some event criteria, which may include a request from a user. Such a process may utilize an element such as active plant 420 described above.

As shown, the process may identify (at 910) the plant. The plant may be identified in various appropriate ways. For instance, there may be a map or other database of plant locations. As another example, the plant may have a graphic code, radio frequency ID, and/or other appropriate identifiers that may be able to be perceived by the device or system of some embodiments. As yet another example, the model plant ID may be retrieved from an active plant data element.

Next, the process may retrieve (at 920) model plant data associated with the plant ID. The model plant data may be retrieved from a local resource such as device storage 145 and/or a remote resource such as server 230.

Process 900 may then retrieve (at 930) current attributes of the plant, such as status, sensor measurements, etc. Such attributes may be retrieved from local and/or remote resources. Next, the process may determine (at 940) whether action is needed. Such a determination may be made in various appropriate ways. For instance, a status may indicate needed action (e.g., “provide light”, “irrigate plant”, etc.). As another example, the attributes may be compared to various threshold values associated with the model plant (e.g., minimum moisture level, maximum pH level, etc.). In some cases, a request may be received from an external resource (e.g., a local controller may request multiple devices to activate a light or irrigation source).

If the process determines (at 940) that no action is needed, the process may end. In some cases, such a determination may be made based on the plant status (e.g., a “dead” plant may not receive light or irrigation regardless of sensor measurements).

If the process determines (at 940) that action is needed, the process may send (at 950) a request for action. Such a request may be sent locally to a resource controllable by a device such as device 100, and/or through various other devices or systems as described above in reference to algorithm 500. In some cases, the request for action may include robotic operations such as destruction of a plant, removal of a plant, a request to plant one or more seeds, etc.

Next, the process may retrieve (at 960) sensor data. Such data may be retrieved from local sensors such as described in reference to device 100 or via other resources such as local controller #210, user device 220, or server 230, for instance.

Process 900 may then determine (at 970) whether any action requirements have been satisfied. Such a determination may be made by, for instance, comparing sensor data to various thresholds. If the process determines (at 970) that the requirements have not been satisfied, the process may repeat operations 960-970 until the process determines (at 970) that the requirements have been satisfied. If the process determines that the requirements have been satisfied, the process may send (at 980) a termination request and then may end. Such a request may be sent locally to a resource controllable by a device such as device 100, and/or through various other devices or systems as described above in reference to algorithm 500.

In some embodiments, the request sent at 950 may include a duration, volume, and/or other appropriate measure such that the resource will terminate the action based on the specified criteria without requiring operations 960-980. Thus, for example, some embodiments may send a request for irrigation and measure moisture level until a threshold is exceeded and a termination request is sent. As another example, some embodiments may send an irrigation request that specifies a volume of water or a duration where the resource is able to automatically terminate operations once the specified criteria is met. Some embodiments may be able to perform both types of request and may utilize operations appropriate for a specific resource.

Some embodiments may generate a log of care (e.g., a list of requested resources, durations, etc.) that may be utilized in heuristic learning of some embodiments. Such a log may be stored within a data element such as element 420.

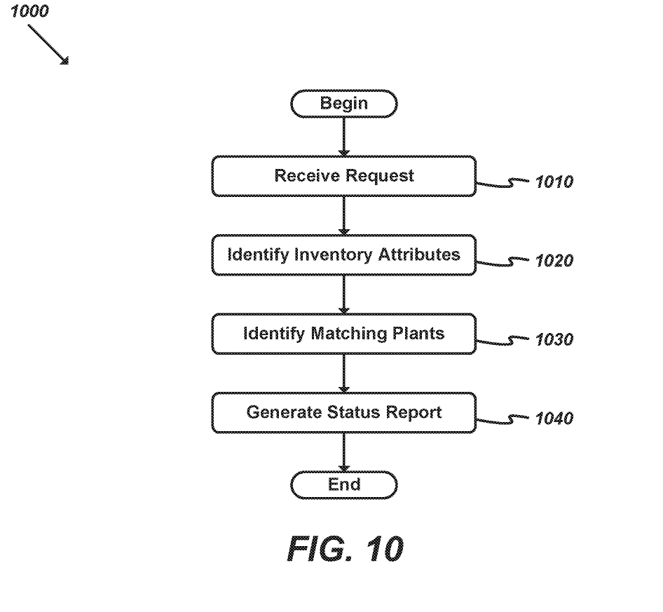

FIG. 10 illustrates a flow chart of an exemplary process 1000 that monitors plant inventory using the smart grow device 100 and/or the smart grow system 200. Such a process may be performed by a device such as smart device 100, local controller 210, user device 220, and/or remote server 230. The process may begin, for instance, when a user initiates a status update through a resource such as a web portal, device application, application programming interface (API), etc. In some embodiments the process may be run at regular intervals or based on some event criteria. Such a process may be used to generate and/or update an element such as site 430 described above.

As shown, the process may receive (at 1010) a request. Such a request may be received from a user device, via an appropriate user interface, and/or other appropriate ways. Alternatively, the process may retrieve a request (e.g., a previously-generated request, a default report request, a scheduled report request, etc.).

Next, the process may identify (at 1020) inventory attributes. Such attributes may be identified by extracting information from the request message, based on default report attributes, and/or other appropriate ways.

Process 1000 may then identify (at 1030) matching plants. Such plants may be identified by evaluating a plant roster from site element 430 and determining which active plant elements 420 listed in the roster match the specified attributes. The process may then generate (at 1040) a status report and then may end. The status report may be sent to a requesting device, placed at an appropriate storage, and/or otherwise made available for use.

Thus, for example, a site manager may be able to receive a list or tabulation of plants that match some criteria (e.g., healthy plants located at site X, live adult plants located at sites X and Y, etc.) in order to manage inventory for auditing purposes. Such a roster may include information about each plant, such as type, location, status, etc. or may simply provide a number of plants (and/or other tabulation such as total weight, total value, viable planters, etc.) that match the criteria.

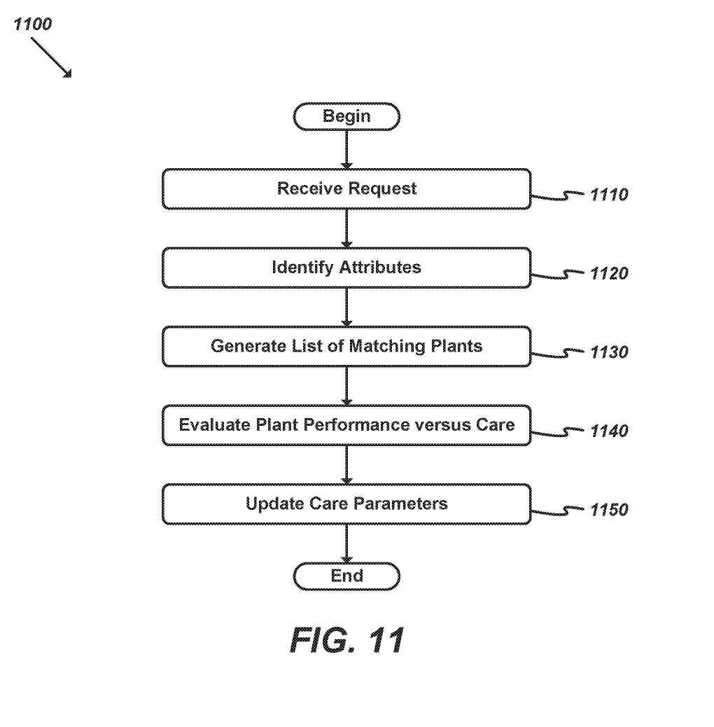

FIG. 11 illustrates a flow chart of an exemplary process 1100 that applies heuristic learning to plant care using the smart grow device 100 and/or the smart grow system 200. Such a process may be performed by a device such as smart device 100, local controller 210, user device 220, and/or remote server 230. The process may begin, for instance, when a user initiates an update through a resource such as a web portal, device application, application programming interface (API), etc. In some embodiments the process may be run at regular intervals or based on some event criteria. Such a process may be used to generate and/or update an element such as model plant 410 described above.

As shown, the process may receive (at 1110) a request. Such a request may be received from a user device, via an appropriate user interface, and/or other appropriate ways. Alternatively, the process may retrieve a request (e.g., a previously-generated request, a default report request, a scheduled report request, etc.).

Next, the process may identify (at 1120) plant attributes. Such attributes may be identified by extracting information from the request message, based on attributes associated with a particular model plant, and/or other appropriate ways.

Process 1130 may then generate (at 1130) a list of matching plants, which may include active and/or inactive plants. Such a list may be generated in various ways, such as evaluating plant rosters associated with one or more sites, evaluating all active and/or inactive plants in a database, etc.

Next, the process may evaluate (at 1140) plant performance versus care. Such evaluation may be made based on various appropriate criteria that may be specified in the request received at 1110, through a default set of criteria, etc. Plant performance may include, for instance, growth rate, plant yield, time to harvest, etc. Such performance may be determined, for instance, based on evaluation of sensor data collected over time and stored in the plant data elements 420. Care may include feeding schedules, moisture thresholds, lighting schedules, etc. where such care may be based on evaluation of logs collected over time and stored in the plant data elements 420. Such care may be directed or specified based on different sets of user-specified criteria, differing availability of resources across sites, and/or other relevant factors.

The process may then update (at 1150) care parameters associated with a specified model plant and then may end. Alternatively, the process may provide reports or data associated with the care parameters for evaluation or future use. The various care parameters may be delineated across a single plant that may be grown in different environments. For instance, the same tomato plant may have different care parameters specified depending on whether the plant is grown outdoors, in a greenhouse, in a hydroponic garden with artificial light, etc.

One of ordinary skill in the art will recognize that processes 600-1100 may be implemented in various different ways without departing from the scope of the disclosure. For instance, various operations may be performed in different orders than shown, other additional operations may be included, various listed operations may be omitted, etc. In addition, some operations and/or sets of operations may be performed iteratively and/or based on some specified criteria. Furthermore, the processes may be divided into multiple sub-processes and/or combined into larger macro processes.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

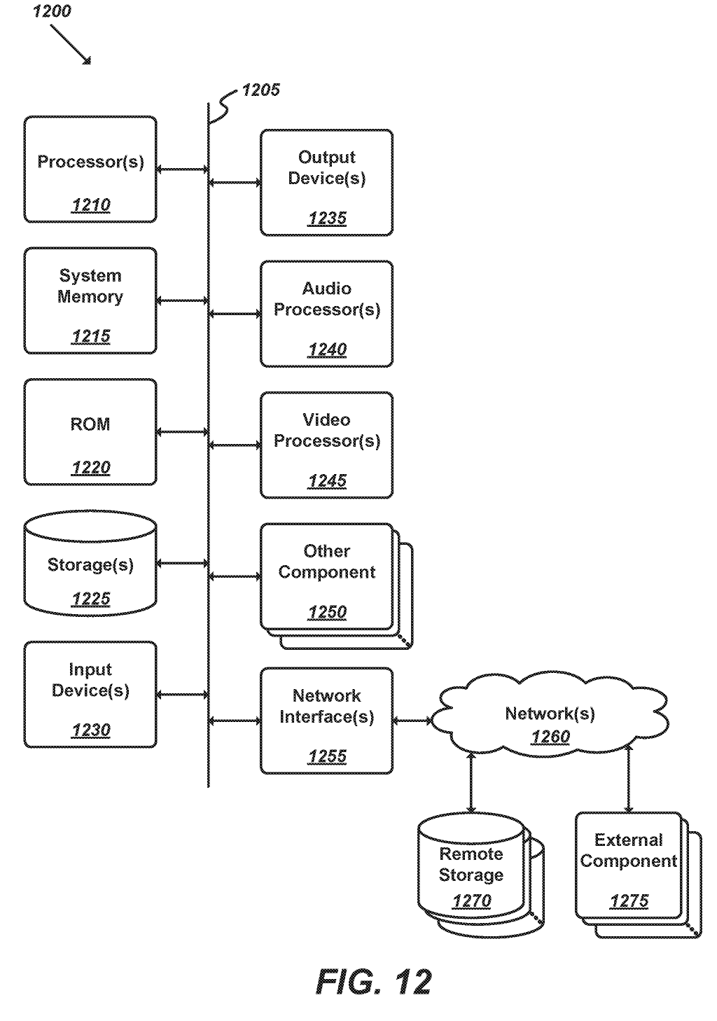

FIG. 12 illustrates a schematic block diagram of an exemplary computer system 1200 used to implement some embodiments. For example, the systems described above in reference to FIGS. 1-3 may be at least partially implemented using computer system 1200. As another example, the processes described in reference to FIGS. 6-11 may be at least partially implemented using sets of instructions that are executed using computer system 1200.

Computer system 1200 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 1200 may include at least one communication bus 1205, one or more processors 1210, a system memory 1215, a read-only memory (ROM) 1220, permanent storage devices 1225, input devices 1230, output devices 1235, audio processors 1240, video processors 1245, various other components 1250, and one or more network interfaces 1255.

Bus 1205 represents all communication pathways among the elements of computer system 1200. Such pathways may include wired, wireless, optical, and/or other appropriate communication pathways. For example, input devices 1230 and/or output devices 1235 may be coupled to the system 1200 using a wireless connection protocol or system.

The processor 1210 may, in order to execute the processes of some embodiments, retrieve instructions to execute and/or data to process from components such as system memory 1215, ROM 1220, and permanent storage device 1225. Such instructions and data may be passed over bus 1205.

System memory 1215 may be a volatile read-and-write memory, such as a random access memory (RAM). The system memory may store some of the instructions and data that the processor uses at runtime. The sets of instructions and/or data used to implement some embodiments may be stored in the system memory 1215, the permanent storage device 1225, and/or the read-only memory 1220. ROM 1220 may store static data and instructions that may be used by processor 1210 and/or other elements of the computer system.

Permanent storage device 1225 may be a read-and-write memory device. The permanent storage device may be a non-volatile memory unit that stores instructions and data even when computer system 1200 is off or unpowered. Computer system 1200 may use a removable storage device and/or a remote storage device as the permanent storage device.

Input devices 1230 may enable a user to communicate information to the computer system and/or manipulate various operations of the system. The input devices may include keyboards, cursor control devices, audio input devices and/or video input devices. Output devices 1235 may include printers, displays, audio devices, etc. Some or all of the input and/or output devices may be wirelessly or optically connected to the computer system 1200.

Audio processor 1240 may process and/or generate audio data and/or instructions. The audio processor may be able to receive audio data from an input device 1230 such as a microphone. The audio processor 1240 may be able to provide audio data to output devices 1240 such as a set of speakers. The audio data may include digital information and/or analog signals. The audio processor 1240 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 1245 (or graphics processing unit) may process and/or generate video data and/or instructions. The video processor may be able to receive video data from an input device 1230 such as a camera. The video processor 1245 may be able to provide video data to an output device 1240 such as a display. The video data may include digital information and/or analog signals. The video processor 1245 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 1250 may perform various other functions including providing storage, interfacing with external systems or components, etc.

Finally, as shown in FIG. 12, computer system 1200 may include one or more network interfaces 1255 that are able to connect to one or more networks 1260. For example, computer system 1200 may be coupled to a web server on the Internet such that a web browser executing on computer system 1200 may interact with the web server as a user interacts with an interface that operates in the web browser. Computer system 1200 may be able to access one or more remote storages 1270 and one or more external components 1275 through the network interface 1255 and network 1260. The network interface(s) 1255 may include one or more application programming interfaces (APIs) that may allow the computer system 1200 to access remote systems and/or storages and also may allow remote systems and/or storages to access computer system 1200 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1200 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

I claim:

1. A smart grow device comprising:
a set of sensors including at least one camera;
a set of care resources; and
a controller able to at least partly control the set of care resources based on evaluation of data received from the set of sensors.

2. The smart grow device of claim 1, wherein the evaluation of data includes comparison of a color image received from the at least one camera to a library of color images associated with a model plant.

3. The smart grow device of claim 2, wherein the evaluation of data further includes determining a first plant status based on the comparison of the color image to the library of color images and identifying a set of care parameters based on the first plant status.

4. The smart grow device of claim 3, wherein the evaluation of data further includes determining a second plant status based on comparison of the received data to a set of threshold values associated with the model plant and updating the set of care parameters based on the second plant status.

5. The smart grow device of claim 1 further comprising a communication module able to communicate across at least one wire or wireless connection to at least one external device.

6. The smart grow device of claim 1, wherein the set of care resources includes at least one of a light source, an irrigation source, and a nourishment source and the set of sensors further includes at least one of a light sensor, a moisture sensor, a scale, and a pH sensor.

7. The smart grow device of claim 1, wherein the set of sensors is able to identify a plant type based on a graphic code or radio frequency identification (RFID).

8. An automated method of providing plant care, the method comprising:
retrieving a set of sensor measurements;
retrieving model plant data including a set of evaluation criteria;
comparing the set of sensor measurements to the set of evaluation criteria in order to determine at least one plant status; and
updating active plant data based on the at least one plant status and the set of sensor measurements.

9. The automated method of claim 8, wherein the set of sensor measurements includes at least one color image.

10. The automated method of claim 9, wherein the set of evaluation criteria comprises an image library.

11. The automated method of claim 8 further comprising:
identifying a needed action based on the at least one plant status and the set of sensor measurements; and
sending a request to a resource associated with the needed action.

12. The automated method of claim 8 further comprising identifying a model plant based at least partly on image data or received radio transmissions included in the set of sensor measurements.

13. The automated method of claim 8 further comprising sending the updated active plant data to a remote server.

14. The automated method of claim 8 further comprising retrieving updated model plant data from a remote server.

15. An automated plant care system comprising:
a set of sensors;
a set of resources;
a plurality of planters; and
at least one controller able to at least partly control the set of resources based on evaluation of data received from the set of sensors.

16. The automated plant care system of claim 15, wherein the set of sensors includes a plurality of sub-sets of sensors, each sub-set of sensors associated with a particular planter from among the plurality of planters.

17. The automated plant care system of claim 15, wherein the set of resources includes a plurality of sub-sets of resources, each sub-set of resources associated with a particular planter from among the plurality of planters.

18. The automated plant care system of claim 15 further comprising a plurality of local controllers, each local controller associated with a particular planter from among the plurality of planters.

19. The automated plant care system of claim 15, wherein the set of resources includes at least one of a light source, an irrigation source, and a nourishment source.

20. The automated plant care system of claim 15, wherein the set of sensors comprises at least one camera and evaluation of data includes comparison of a color image received from the at least one camera to a library of color images associated with a model plant.
